(19) United States
(12) Patent Application Publication
(10) Pub. No.: US 2026/0245110 A1
(43) Pub. Date: Aug. 20, 2026

(54) TECHNIQUES FOR DYNAMIC INNOVATION PREDICTION UTILIZING AN ARTIFICIAL INTELLIGENCE ARCHITECTURE

(71) Applicant: GARRISON OLSON LLC, Chicago, IL (US)

(72) Inventor: Ryan Garrison, Chicago, IL (US)

(21) Appl. No.: 19/054,657

(22) Filed: Feb. 14, 2025

(51) Int. Cl. G06Q 30/0204

(52) U.S. Cl. CPC G06Q 30/0204

(57) ABSTRACT

Systems and methods for improved modular predictive analysis may include obtaining penetration data comprising one or more penetration data components and effectiveness data comprising one or more effectiveness data components; determining one or both of: a removal of a portion of the penetration data, and/or effectiveness data using an outlier detection algorithm, or (i) a penetration value based on the penetration data and one or more weighting values and (ii) an effectiveness value based on the effectiveness data and one or more weighting values; determining an index value based at least in part on a weighted combination of the penetration value and the effectiveness value; generating a data object indicating the index value; obtaining a real-time update to at least one of the penetration data or the effectiveness data; and determining, by using a Bayesian updating process, an updated index value.

### FIELD OF THE INVENTION

The present techniques relate to data analytics, and more particularly, to strategy optimization prediction utilizing an artificial intelligence architecture, including modular predictive analysis to determine the impacts of various factors on the strategy.

### BACKGROUND

The data analytics field includes several traditional techniques to determine strategies (e.g., marketing) related to particular objects (e.g., items). However, the data analytics field is plagued by static evaluation techniques that lack the ability to adequately incorporate the vast data sets available for objects during their lifespans, much less dynamically adapt to data updates for such objects in real-time. For example, fluctuating sentiment towards an object, an object trait, and/or an object category overall may consistently fluctuate during the lifespan of the object, object availability constantly changes due to the continuous selling of the object, and the object's price may vary due to a wide variety of external events. These issues are further compounded, as existing systems are generally unable to account for the interdependencies these various factors have, much less the real-time implications of such interdependencies. For example, changing sentiment towards an object may affect its availability in the market, which may in turn affect the object's price due to changing demand. Moreover, as a result of these and other issues, existing data analytic techniques frequently lack the ability to generate both granular and broader insights that capture the implications of such nuanced and vast datasets.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 depicts an example computing environment for modular predictive analysis, according to embodiments described herein.

FIG. 2 depicts an example scenario for generating an index value, according to embodiments described herein.

FIG. 3 depicts an example scenario for generating and iteratively updating weighting values, according to embodiments described herein.

FIG. 4 depicts a block diagram of an example method for generating an index value, according to embodiments described herein.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Complex and continuously changing market conditions indicate a need for more dynamic, nuanced approaches when determining strategies associated with an object. The techniques described herein provide an improved approach to optimize strategies corresponding to objects by leveraging complex and detailed datasets in combination with machine learning architectures configured to output strategy optimization predictions, and updating such machine learning architectures over time (e.g., in real-time) to continuously update/re-optimize the strategies as necessary during the lifespan of the object.

The techniques described herein generate an index value, which generally indicates an overall likelihood of success and/or a performance of an object. The index value provides a compact and accurate way of representing data associated with the different aspects of the likelihood of success of the object. The systems described herein may determine the index value by combining weighted index component values, each of which may be calculated based on weighted data components. The weights of the index component values and the data components may be generated by employing various machine learning algorithms, which may be configured to dynamically update such weights in real-time (e.g., seconds, minutes) based on updates to the data associated with the object. Further, in contrast to conventional techniques, the present techniques include iteratively updating a machine learning model parameters to generate more accurate results, for example, utilizing Bayesian updating and/or other similar techniques. This iterative updating changes the operation of the machine learning models described herein to more accurately determine index values and/or other values over time, as increased data intake associated with particular objects more accurately informs the tuning/adjustment of the model parameters and/or hyperparameters.

The present techniques represent a significant improvement to the field of data analytics, in comparison to conventional techniques. As mentioned, existing techniques often utilize static models that lack granularity as they generally rely on superficial data values without considering their interrelationships or other more nuanced implications. Additionally, these static models lack flexibility, as they typically do not account for the different phases of an object's lifecycle where the relative influence of certain data values changes as the object transitions between phases. Moreover, such static models are frequently do not incorporate real-time updates based on updated object data, and thus lack the ability to accurately convey up-to-date, optimized predictions.

The techniques of the present disclosure overcome these challenges of existing techniques in various manners. For example, the present techniques provide a dual layer of weighting that increases the accuracy of the index value by providing granular control over component data, relative to existing techniques. This dual weighting may include weighting data components that are used to determine an index component value, as well as weighting the index component values themselves to determine the index value. For example, an index value may include an index component value such as a reach value, which may be modified by a weighting value for determining the index value. Continuing the example, the reach value may include a potential reach component, which may be modified by a weighting value for determining the reach value. Accordingly, the present techniques enable the adjustment of individual data components and their contributions to the overall index value with a substantially higher degree of specificity than was possible using existing techniques. By determining and applying weights not only to the index component values but also to the underlying data components that contribute to these index component values, the present techniques provide a mechanism to fine-tune the analysis based on the significance or relevance of each component at different stages of an object's lifecycle.

Further, the present techniques are configured to change/adjust these weighting values over time based on different stages of the object's lifecycle, thus providing more accurate and useful analysis for an object at each stage of the lifecycle than existing techniques are capable of providing. In particular, the layered weighting approach allows for dynamic adjustment of the analysis to reflect changes over time, offering a more detailed and accurate representation of the object's status or performance. Additionally, the present techniques update the weighting values in real-time based on updated object data. The techniques of the present disclosure thereby quickly adjust the index value to changes in the data and ensure that any recommendations/predictions (e.g., launch success, price adjustment, distribution locations) based on the index value remain accurate to avoid issues associated with outdated recommendations from which existing techniques commonly suffer. The present techniques thereby address the limitations of static models by incorporating the interrelationships between data components and their varying importance over time. Consequently, this dual weighting mechanism enhances the granularity of the data analysis, leading to more precise predictions than those achievable with existing techniques that lack such depth and adaptability in their analytical models.

The present techniques also represent a substantial improvement in the functioning of a computer and/or computing device, as compared to existing techniques. For example, existing techniques fail to account for changes over time. During the lifecycle of an object, some index value components may have a greater impact and/or be more important than others. However, conventional techniques utilize static models, which may be initially accurate but produce inaccurate results over time and fail to take into account the lifecycle of an object and other changes to data relating to the object. In contrast, the techniques of the present disclosure iteratively update/re-train a machine learning model such that it generates more accurate outputs. Additionally, the machine learning model updates (e.g., through a Bayesian process) its own internal probability algorithms such that predictions become more accurate over time. Existing techniques lack such accuracy enhancing measures, such that the present techniques improve the functioning of the computing device executing such machine learning models by enhancing the accuracy of the device's outputs and simultaneously minimizing the amount of processing resources required to provide such outputs through the continuous/iterative model updating/re-training processes described herein.

In certain embodiments, the techniques of the present disclosure utilize machine learning to detect and remove outliers from the data/calculations, further improving the accuracy of the index value. Many existing techniques perform the same static analysis for every object by including most/all received data associated with the object, including those with relatively limited distribution and/or otherwise having limited (e.g., small) datasets. In these instances, outliers within the dataset can cause significantly larger errors in the analysis results than in substantially larger datasets, and existing techniques commonly produce erroneous results by incorporating such outliers in their analysis. By contrast, the present techniques generate index value with high levels of accuracy for all objects, regardless of distribution breadth or dataset size through the outlier detection and removal performed by machine learning models. Thus, the present techniques may be especially advantageous for objects with limited distribution and/or otherwise limited datasets by consistently and reliably producing accurate index values that do not incorporate outliers within the associated datasets of such objects. Accordingly, the present techniques further improve the functioning of the computing device executing such machine learning processes, as compared to existing techniques, by reducing erroneous outputs and consequently reducing the superfluous use of processing components to determine such erroneous outputs.

Overall, the specific processing architecture, predictive capabilities, dynamic adjustments to weighting values, and updating and retraining of a machine learning model enable the present techniques to provide reliable, accurate predictions and recommendations to adjust, change, and/or otherwise modify strategies for various objects in a manner that is unachievable using conventional techniques.

### Example Computing Environment

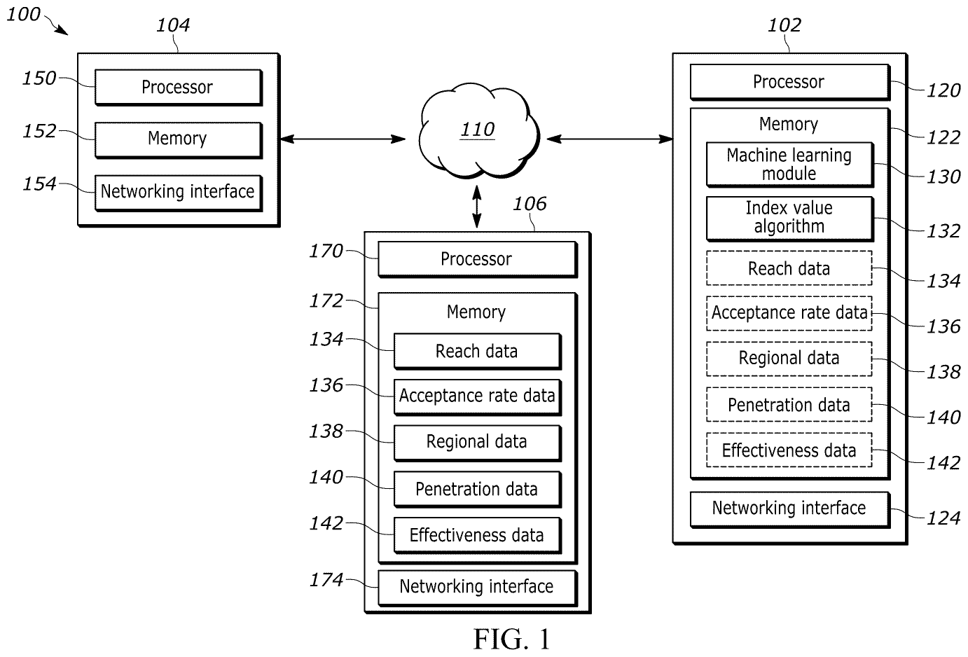

Turning to the Figures, FIG. 1 depicts an example computing system 100 in which various embodiments of the present disclosure may be implemented. The example computing system 100 may generate an index value based on various index value component values. Of course, it should be appreciated that, while the various components of the exemplary computing system 100 (e.g., user device 104, external server 106, etc.) are illustrated in FIG. 1 as single components, the exemplary computing system 100 may include multiple (e.g., dozens, hundreds, thousands) of each of the components that are simultaneously connected to the network 110 at any given time.

Generally speaking, the exemplary computing system 100 may include a central server 102, an external server 104, and a user device 106. The central server 102 may generally receive data from the external server 104 and/or the user device 106 connected to the network 110 and may process the data in accordance with one or more sets of instructions contained in the memory 122 to output any of the values/responses described herein. The central server 102 may include one or more processors 120, one or more memories 122, and a networking interface 124. The memory 122 may include various sets of executable instructions that are configured to analyze data received at the central server 102 and analyze that data to output various values. These executable instructions include, for example, a machine learning module 130, an index value algorithm 132, reach data 134, acceptance rate data 136, regional data 138, penetration data 140, and effectiveness data 142. The memory 122 may also store additional data and/or databases.

For example, the central server 102 may receive or store reach data, acceptance rate data, and/or regional data. The reach data 134 may include one or more reach data components, which may include a potential reach in a target segment and/or benchmark reach in a category. The acceptance rate data 136 may include one or more acceptance rate data components, which may include an interest score, a sales projection and/or a time-to-market. The regional data 138 may include one or more regional data components, which may include an average price in location and/or a national average price. The penetration data 140 may include one or more penetration data components, which may include retail locations with an object (e.g., product) and/or total target retail locations. The effectiveness data 142 may include variations stocked by a retailer and/or total variations offered. The reach data 134 may be used to generate an reach value, the acceptance rate data 136 may be used to generate an acceptance rate value, the regional data 138 may be used to generate a regional value, the penetration data 140 may be used to generate a penetration value, and the effectiveness data 142 may be used to generate an effectiveness value, which all may be used to generate an index value. In some embodiments, one or more of the reach data, acceptance rate data, and/or regional data may be provided to the machine learning module 130 to generate additional reach data, acceptance rate data, and/or regional data, which may be used to calculate the reach value, acceptance rate value, and/or regional value. In some embodiments, the central server 102 may store additional data such as alignment data, impact range data, penetration data, distribution data, effectiveness data, and/or substitution data to determine additional values such as an alignment value, impact range value, penetration value, distribution value, effectiveness value, and/or substitution value.

The central server 102 may receive the reach data, acceptance rate data, and/or regional data from a user device 104 and/or an external server 106. In some embodiments, the central server 102 may receive one or more additional types of data from the user device 104 and/or external server 106.

In some embodiments, the central server 102 may be configured to implement machine learning such that the central server 102 “learns” to analyze, organize, and/or process data without being explicitly programmed. algorithms. The memory 122 may include a machine learning module 130 to train and operate and/or implement machine learning models. For example, generating the reach data components, acceptance rate data components, regional data components may be generating via the machine learning module 130. In some embodiments, the weighting values for the reach data components, acceptance rate data components, regional data components, and/or the weighting values for the reach value, acceptance rate value, and/or regional value used in the index value algorithm 140 may be generated utilizing artificial intelligence and/or machine learning techniques.

The machine learning module 130 may employ supervised or unsupervised machine learning techniques, which may be followed or used in conjunction with reinforced or reinforcement learning techniques. In some embodiments, at least one of a plurality of machine learning methods and algorithms may be applied, which may include but are not limited to: linear or logistic regression, instance-based algorithms, regularization algorithms, decision trees, Bayesian networks, naïve Bayes algorithms, cluster analysis, association rule learning, neural networks (e.g., convolutional neural networks, deep learning neural networks, combined learning module or program), deep learning, combined learning, reinforced learning, dimensionality reduction, support vector machines, k-nearest neighbor algorithms, random forest algorithms, gradient boosting algorithms, Bayesian program learning, voice recognition and synthesis algorithms, image or object recognition, optical character recognition, natural language understanding, and/or other ML programs/algorithms either individually or in combination. In various embodiments, the implemented machine learning methods and algorithms are directed toward at least one of a plurality of categorizations of machine learning, such as supervised learning, unsupervised learning, and reinforcement learning. Other types of machine learning may also be employed, including deep or combined learning techniques.

After training, machine learning programs (or information generated by such machine learning programs) may be used to evaluate additional data. Such data may be and/or may be related to index value data, user device data, and/or other data that was not included in the training dataset. The trained machine learning programs (or programs utilizing models, parameters, or other data produced through the training process) may accordingly be used for determining, assessing, analyzing, predicting, estimating, evaluating, or otherwise processing new data not included in the training dataset. Such trained machine learning programs may, therefore, be used to perform part or all of the analytical functions of the methods described elsewhere herein.

It is to be understood that supervised machine learning and/or unsupervised machine learning may also comprise retraining, relearning, or otherwise updating models with new, or different, information, which may include information received, ingested, generated, or otherwise used over time. Further, it should be appreciated that the index value algorithm 132 may be used to output index values and/or any other values or combinations thereof using artificial intelligence or, in alternative aspects, without using artificial intelligence.

In some embodiments, the machine learning models may be updated, e.g., through Bayesian updating, over time. A machine learning model may incorporate updated information to generate more accurate predictions. The model may begin with a parameter (e.g., a probability) representing an initial belief. The model may then receive updated data (e.g., updated crowdsourced data regarding an object, data about the quantity of an object in a particular region, demand for an object, etc.) and update the parameter based on the updated data.

Moreover, although the methods described elsewhere herein may not directly mention machine learning techniques, such methods may be read to include such machine learning for any determination or processing of data that may be accomplished using such techniques. In some aspects, such machine learning techniques may be implemented automatically upon occurrence of certain events or upon certain conditions being met. In any event, use of machine learning techniques, as described herein, may begin with training a machine learning program, or such techniques may begin with a previously trained machine learning program.

The memory 122 may include an index value algorithm 132. The central server 102 may execute the index value algorithm 132 to determine an index value based on the reach data, acceptance rate data, regional data, penetration data, effectiveness data, and/or other types of data (e.g., retrieved/accessed from the data 134-142, and/or received from user device 104). The index value algorithm 132 may generate a data object including an index value for user and/or other computer or bot consumption. In some embodiments, the index value algorithm may be 132 may be modified and/or adjusted over time. For example, the weighting values of component values (e.g., reach value, acceptance rate value, regional value, penetration value, effectiveness value, etc.) of the index value algorithm 132 may be dynamically updated based on updates to the reach data 134, acceptance rate data 136, regional data 138, penetration data 140, and/or effectiveness data 142. In some embodiments, the index value algorithm 132 may further include additional weighted values such as a weighted alignment value, impact range value, distribution value, effectiveness value, and/or substitution value. In some embodiments, the weighting values used in the index value algorithm 132 may be dynamically updated (e.g., in real-time, such as seconds, minutes, etc.) in response to updates (including real-time updates) to the reach data 134, acceptance rate data 136, regional data 138, penetration data 140, effectiveness data 142, and/or other types of data.

Generally, the user device 104 may be or include any device that is associated with (e.g., configured to connect with, etc.) a particular user, who may connect to and/or otherwise provide data (e.g., index data) that may be transmitted to the central server 102 through the network 110. In certain embodiments, the user device 104 may be a personal computing device of that user, such as a smartphone, a tablet, smart glasses, or any other suitable device or combination of devices (e.g., a smart watch plus a smartphone) with wireless communication capability. In the embodiment of FIG. 1, the user device 104 may include a processor 150, a memory 152, and a networking interface 154.

The user device 104 may be communicatively coupled to the central server 102 and/or the external server 106. For example, the user device 104 and the central server 106 and/or the external server 106 may communicate via USB, Bluetooth, Wi-Fi Direct, Near Field Communication (NFC), etc. For example, the central server 102 may transmit an index value and/or a set of index values across a communication channel of the computing system 100, and/or any other values or combinations thereof to the user device 104 via the networking interface 124, which the user device 104 may receive via the networking interface 156.

The external server 106 may be or include computing servers and/or combinations of multiple servers storing data that may be accessed/retrieved by the central server 102 and/or the user device 104. The data stored by the external server 106 may include data that index value algorithm 132 may retrieve and/or otherwise access to perform the analysis described herein. For example, the external server 106 may be a data repository for the central server 102 administrator, and may store the reach data 134, acceptance rate data 136, regional data 138, penetration data 140, and/or effectiveness data 142 received at the central server 102 before, during, or after processing via the index value algorithm 132 to maintain a database of all index data over time. The external server 106 may include a processor 170, a memory 172, and a networking interface 174. In some embodiments, the external server 106 may be owned or controlled by an entity other than the entity that owns or controls a central server 102. For example, the external server 106 may host social media content which may be retrieved (e.g., as crowdsourced data) by the central server 102 to determine one or more sentiments towards an object, an object trait, and/or an object category.

Each of the processors 120, 150, and 170 may include any suitable number of processors and/or processor types. For example, the processors 120, 150, and 170 may include one or more CPUs and one or more graphics processing units (GPUs). Generally, each of the processors 120, 150, and 170 may be configured to execute software instructions stored in each of the corresponding memories 122, 152, and 172. The memories 122, 152, and 172 may include one or more persistent memories (e.g., a hard drive and/or solid state memory) and may store one or more applications, modules, and/or models, such as the machine learning module 130 and/or the index value algorithm 132.

The networking interface 124 may enable the central server 102 to communicate with the user device 104, the external server 106, and/or any other suitable devices or combinations thereof. More specifically, the networking interface 124 enables the central server 102 to communicate with each component of the exemplary computing system 100 across the network 110 through their respective networking interfaces 154 and 174. The networking interface 114 may support wired or wireless communications, such as USB, Bluetooth, Wi-Fi Direct, Near Field Communication (NFC), etc. The networking interface 114 may enable the central server 102 to communicate with the various components of the exemplary computing system 100 via a wireless communication network such as a fifth-, fourth-, or third-generation cellular network (5G, 4G, or 3G, respectively), a Wi-Fi network (802.11 standards), a WiMAX network, a wide area network (WAN), a local area network (LAN), etc.

Moreover, the network 110 may be a single communication network, or may include multiple communication networks of one or more types (e.g., one or more wired and/or wireless personal or local area networks (PANs or LANs), and/or one or more wide area networks (WANs) such as the Internet). In some embodiments, the network 110 includes multiple, entirely distinct networks (e.g., one or more networks for communications between the central server 102 and the user device 104, and a separate, Bluetooth or wireless LAN (WLAN) network for communications between the central server 102 and the external server 106, and so on).

It will be understood that the above disclosure is one example and does not necessarily describe every possible embodiment. As such, it will be further understood that alternate embodiments may include fewer, alternate, and/or additional steps or elements.

### Generating an Index Value

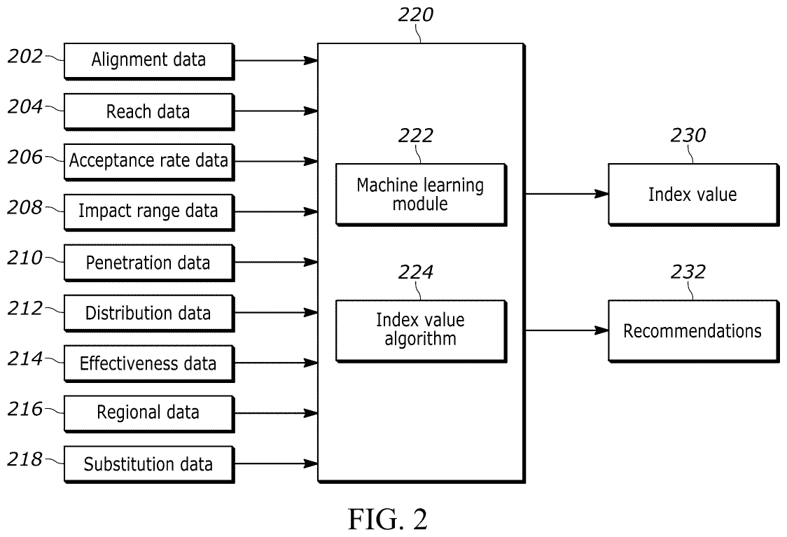

FIG. 2 depicts an example scenario 200 in which an index value algorithm receives a plurality of input data to generate an index value and/or recommendations, in accordance with various embodiments described herein. Generally, the example scenario 200 illustrates a combination 220 of a machine learning module 222 (e.g., machine learning module 130) and an index value algorithm 224 (e.g., the index value algorithm 132 of FIG. 1) receiving one or more data inputs 202-218 to generate one or more outputs 230 and 232. The data inputs 202-218 may generally include any of the inputs described herein, such as alignment data 202, reach data 204, acceptance rate data 206, impact range data 208, penetration data 210, distribution data 212, effectiveness data 214, regional data 216, and/or substitution data 218. The one or more outputs 230 and 232 may include, for example, an index value 230, and recommendations 232.

As illustrated in FIG. 2, the combination 220 may receive any suitable number of inputs. For example, in certain scenarios, the combination 220 may only receive reach data 204, acceptance rate data 206, and regional data 216. In some embodiments, the combination 220 may receive one or more additional inputs such as the alignment data 202, the impact range data 208, the penetration data 210, the distribution data 212, the effectiveness data 214, and/or the substitution data 218. The combination 220 may output a data object indicating an index value 230 in response to receiving one or more of the data inputs 202-218. In some embodiments, the combination 220 may output one or more recommendations 232. For example, the machine learning module 222 may generate recommendations such as a recommended price adjustment for an object, target retail locations, marketing strategies, target markets, etc.

The inputs 202-218 may be used to determine index component values, which are then used to calculate the index value 230. For example, the alignment data 202 may be used to determine an alignment value, the reach data 204 may be used to determine an reach value, the acceptance rate data 206 may be used to determine an acceptance rate value, the impact range data 208 may be used to determine an impact range value, the penetration data 210 may be used to determine a penetration value, the distribution data 212 may be used to determine a distribution value, the effectiveness data 214 may be used to determine an effectiveness value, the regional data 216 may be used to determine a regional value, and the substitution data 218 may be used to determine a substitution value. In some embodiments, each data component that comprises an index component value may be weighted, as described below. In some embodiments, the weighting values may be a value from 0 to 1 (inclusive). In some embodiments, a higher weighting value may indicate more importance of a data component to an index component value and a lower weighting value may indicate less importance of a data component to an index component value. For example, a weighting value of 0 for a data component may indicate that that data component is irrelevant to an index component value for a particular object.

The alignment data 202 may include one or more alignment data components, which may include a motivational score for a product attribute (e.g., trait) and/or an average motivational score for a category. For example, a category may be a type of product such as frozen pizza, and the product attribute may be a trait or an attribute such as sorghum flour or Korean flavor. The motivational score for a product attribute may indicate interest in a product attribute and may be based on surveys and/or social media data. The average motivational score for a category may include a baseline level of interest in a category of product. As noted above, the alignment data 202 may be used to determine an alignment value, which may indicate how well the attributes of a particular product matches with consumer interest and motivation. In some embodiments, the alignment value may be calculated using the equation:

$$Alignment Value = ( {w}_{1} \times Motivational Score for Product Attribute ) / ( {w}_{2} \times Average Motivational Score in Category ) , \qquad ( 1 )$$

where w₁ and w₂ are weighting values.

The reach data 204 may include one or more reach data components, which may include a potential reach in a target segment and/or benchmark reach in a category. The potential reach in a target segment may be an estimated number of households and/or consumers in a target demographic who are likely to be interested in a product, and may be based on surveys and/or demographic studies. The benchmark reach in a category may be an average number of households and/or consumers interested in a category of product. As noted above, the reach data 204 may be used to determine a reach value, which may estimate the potential reach of a particular product within a particular demographic and may indicate if the product gain traction with the target demographic. In some embodiments, the reach value may be calculated using the equation:

$$Reach Value = ( {w}_{1} \times Potential Reach in Target Segment ) / Benchmark Reach in Category , \qquad ( 2 )$$

where w₁ is a weighting value.

The acceptance rate data 206 may include one or more acceptance rate data components, which may include an interest score, a sales projection and/or a time-to-market. The interest score may indicate interest in a product, and may be based on surveys, trend responses, and/or social media data. The sales projection may be a projected number of units expected to be sold within an initial launch period of a product. The time-to-market may be an estimated time (e.g., in months) for the product to reach full distribution or intended market coverage. As noted above, the acceptance rate data 206 may be used to determine an acceptance rate value, which may measure the rate at which the product is likely to gain consumer acceptance and achieve initial sales. In some embodiments, the acceptance rate value may be calculated using the equation:

$$Acceptance Rate Value = [ ( {w}_{1} \times Interest Score ) \times ( {w}_{2} \times Sales Projection ) ] / Time - to - Market , \qquad ( 3 )$$

where w₁ and w₂ are weighting values. In some embodiments, the acceptance rate value may account for change in consumer behavior over time. For example, an interest score may slowly diminish after an initial spike of interest upon release of a product. The change in the acceptance rate over time may be modeled, e.g., with an exponential decay function, such as:

$$Acceptance Rate Value = {V}_{0} \cdot {e}^{- λ t} , \qquad ( 4 )$$

wherein V₀ is an initial acceptance rate value, λ is a rate of decline, and t is time. The acceptance rate may be used to determine demand at a specific point in time. For example, the acceptance rate may be used to determine a future demand for an object.

The impact range data 208 may include one or more impact range data components, which may include a motivational reach for a product trait (e.g., attribute) and/or an average trait influence. The motivational reach for a product trait may be a number of consumers interested in a product attribute outside of the category of a particular product and may be based on surveys and/or market research. For example, the motivational reach for a product trait may be a number of consumers interested in the trait of sorghum flour outside of the category of frozen pizzas. The average trait influence may be an average level of interest in an attribute across all categories of the product. In some embodiments, the impact range value may be calculated using the equation:

$$Impact Range Value = ( {w}_{1} \times Motivational Reach for Product Trait ) / Average Trait Influence , \qquad ( 5 )$$

where w₁ is a weighting value.

The penetration data 210 may include one or more penetration data components, which may include retail locations with product locations and/or total target retail locations. The retail locations with a product may be a number of stores or locations currently carrying the product. The total target retail locations may be a total number of stores or locations in a target retail network where a product may potentially be distributed. In some embodiments, the penetration value may be calculated using the equation:

$$Penetration Value = ( {w}_{1} \times Retail Locations with Product ) / ( {w}_{2} \times Total Target Retail Locations ) , \qquad ( 6 )$$

where w₁ and w₂ are weighting values.

The distribution data 212 may include one or more distribution data components, which may include current locations with product locations and/or total target locations. The current locations with a product may be a number of individual stores currently carrying the product. The total target locations may be a total number of stores in the target distribution network where the product could potentially be carried. In some embodiments, the distribution value may be calculated using the equation:

$$Distribution Value = ( {w}_{1} \times Current Locations with Product ) / ( {w}_{2} \times Total Target Locations ) , \qquad ( 7 )$$

where w₁ and w₂ are weighting values.

The effectiveness data 214 may include one or more effectiveness data components, which may include variations stocked by a retailer and/or total variations offered. A variation of a product may be associated with and identified by a stock-keeping unit (SKU), with different variations having different SKUs. The variations stocked by a retailer may be a number of variations actively stocked by the retailer. The total variations offered may be a total number of variations offered by the maker of the product. In some embodiments, the effectiveness value may be calculated using the equation:

$$Effectiveness Value = ( {w}_{1} \times Variations Stocked by Retailer ) / ( {w}_{2} \times Total Variations Offered ) , \qquad ( 8 )$$

where w₁ and w₂ are weighting values.

The regional data 216 may include one or more regional data components, which may include an average price in location and/or a national average price. The average price in location may be an average selling price of a product in a specific region or location. The national average price may be an average price of the product across all regions or locations. In some embodiments, the regional value may be calculated using the equation:

$$Regional Value = [ ( {w}_{1} \times Average Price in Location ) - ( {w}_{2} \times National Average Price ) ] / ( {w}_{3} \times National Average Price ) , \qquad ( 9 )$$

where w₁, w₂, and w₃ are weighting values.

The substitution data 218 may include one or more substitution data components, which may include competitor product launches, a market share of competitor products, and/or a category growth rate. The competitor product launches may be a number of similar or substitute products introduced by competitors within a particular timeframe. The market share of competitor products may be an estimated market share or number of sales of similar or substitute products launched by competitors. The category growth rate may be an overall growth rate of a category of the product. In some embodiments, the substitution value may be calculated using the equation:

$$Substitution Value = [ ( {w}_{1} \times Competitor Product Launches ) \times ( {w}_{2} \times Market Share of Competitor Products ) ] \times ( {w}_{3} \times Category Growth Rate ) , \qquad ( 10 )$$

where w₁, w₂, and w₃ are weighting values.

In some embodiments, the machine learning module 222 may be used to generate alignment, reach, acceptance rate, impact range, penetration, distribution, effectiveness, regional, and/or substitution data components. For example, the machine learning module 222 may identify (e.g., via natural language processing techniques), from crowdsourced data, sentiments towards a product to determine an interest score, which is an acceptance rate data component. The machine learning module 222 may also be trained to predict sales projection data, generate demographic groups, etc., and/or generate recommendations 232 such as price adjustments, target retail locations, target markets, marketing strategies, etc.

In some embodiments, the machine learning module 222 may employ supervised learning, which involves identifying patterns in existing data to make predictions about subsequently received data. Specifically, a machine learning model may be “trained” using training data, which includes example inputs and associated example outputs. For example, supervised learning techniques may be used to identify sentiments towards a product, product trait, and/or product category, which may be used to generate an interest score.

In other embodiments embodiment, the machine learning module 222 may employ unsupervised learning, which involves finding meaningful relationships in unorganized data. Unlike supervised learning, unsupervised learning does not involve user-initiated training based upon example inputs with associated outputs. Unorganized data may include any combination of data inputs and/or machine learning outputs. For example, a machine learning model may use unsupervised learning to detect outliers in the data inputs 202-218.

In some embodiments, the machine learning module 222 may employ reinforcement learning, which involves optimizing outputs based upon feedback from a reward signal. A machine learning model may receive a user-defined reward signal definition, receive a data input, utilize a decision-making model to generate a machine learning output based upon the data input, receive a reward signal based upon the reward signal definition and the machine learning output, and alter the decision-making model so as to receive a stronger reward signal for subsequently generated machine learning outputs. For example, reinforcement learning may be utilized to recommend pricing for an object and/or recommend distribution locations for an object.

In some embodiments, the machine learning module 222 may identify (e.g., via natural language processing techniques), from crowdsourced data, sentiments towards a product to determine an interest score, which may be an acceptance rate data component. In some embodiments, the crowdsource data may be retrieved by employing web scraping techniques to extract data from a social media account and/or other source available on the internet. The crowdsourced data may include text data, such as text data describing a particular object and/or object trait. The central server 102 may fetch an account from a server hosting content (e.g., external server 106). The central server 102 may then parse the account to extract data from the account. In some embodiments, the central server 102 may additionally or alternatively use an API to retrieve data from a social media account or other internet source. The API may be implemented as an endpoint accessible via a web service protocol, such as representational state transfer (REST), Simple Object Access Protocol (SOAP), JavaScript Object Notation (JSON), etc. The text data may be separated into words (i.e., tokenized) for further analysis. In some embodiments, the text may be converted utilizing bag-of-words or word embeddings. In some embodiments, one or more sentiments may be identified from the text using machine learning models and techniques such as naïve Bayes, support vector machines, and/or deep learning. Additionally or alternatively, sentiments may be identified by using a lexicon-based approach. A positive, negative, or neutral sentiment may be identified for the text data. In some embodiments, sentiment analysis may include fine-grained and/or graded sentiment analysis, aspect-based sentiment analysis, and/or emotional detection.

In some embodiments, data components and index component values may influence other index component values. For example, an alignment value may have an impact on an acceptance rate value and/or a penetration value, as interest in an object may increase the sales of an object. In some embodiments, a weighted cross-influence index indicating a level of influence between the index component values may be calculated using the equation:

$${M}_{influence} = {w}_{1} {M}_{allignment} + {w}_{2} {M}_{reach} + {w}_{3} {M}_{acceptance rate} + {w}_{4} {M}_{impact range} + {w}_{5} {M}_{penetration} + {w}_{6} {M}_{distribution} + {w}_{7} {M}_{effectiveness} + {w}_{8} {M}_{regional} + {w}_{9} {M}_{substitution} , \qquad ( 11 )$$

where w₁, w₂, w₃, w₄, w₅, w₆, w₇, w₈, and w₉ are weighting values and each M value indicates the influence of an index value component value. In certain embodiments, each individual M value and/or the composite M_{influence} value(s) may indicate and/or be used to determine which individual index component values have more than others for any particular object. In such embodiments, the M values and their weightings may reflect their influence on desired outcomes for the object.

Various combinations of the index value component values (e.g., alignment value, reach value, acceptance rate value, impact range value, penetration value, distribution value, effectiveness value, regional value, and/or substitution value) may be used to determine an index value 230. In some embodiments, the index value 230 may be determined based on the reach value, the acceptance rate value, and the regional value. In some embodiments, the index value algorithm 224 may use the equation:

$$Index Value = {w}_{1} ( Alignment Value ) \times {w}_{2} ( Reach Value ) \times {w}_{3} ( Acceptance Rate Value ) \times {w}_{4} ( Impact Range Value ) \times {w}_{5} ( Penetration Value ) \times {w}_{6} ( Distribution Value ) \times {w}_{7} ( Effectiveness Value ) \times {w}_{8} ( Regional Value ) \times {w}_{9} ( Substitution Value ) , \qquad ( 12 )$$

where w₁, w₂, w₃, w₄, w₅, w₆, w₇, w₈, and w₉ are weighting values. In some embodiments, the weighting values may be a value from 0 to 1 (inclusive). In some embodiments, a higher weighting value may indicate more importance of an index component value to an index value and a lower weighting value may indicate less importance of an index component value to an index value. For example, a weighting value of 0 for an index value component value may indicate that that index value component is irrelevant to the overall index value for a particular object.

Generally speaking, the index value 230 may represent a score representing a likelihood of success of an object (e.g., a product) and/or innovation (e.g., incremental innovation or disruptive or radical innovation) in an object. For example, the index value 230 may indicate the likelihood of success of using sorghum flour in pizza. The index value 230 may be classified as high, mid-ranged, or low. For example, a high score may be associated with an index value range of 0.7-1.0, a mid-range score may be associated with an index value range of 0.4-0.69, and a low score may be associated with an index value range of 0-0.39. A high index value 230 for an incremental innovation may be interpreted as the innovation and/or product having a strong alignment with consumer demand, widespread distribution, and is effectively positioned against other competitors, and may indicate that the product has a high probability of gaining traction and stable growth in the market. A high index value 230 for a disruptive or radical innovation may indicate that the innovation and/or product meets a unique demand, has effectively penetrated retail locations, and shows resilience against competitors, and may be positioned for rapid adoption even in niche markets. A mid-range index value 230 for an incremental innovation may indicate moderate alignment with consumer preferences and average market penetration, and may indicate that while the product may gain traction it could face slower growth or regional variability in demand. A mid-range index value 230 for a disruptive or radical innovation may indicate there is some interest in the innovation and/or product, but it may not be ready for market or the brand may not be optimally-positioned to introduce the product to market. The product may gain traction in some regions or with some early adopters but may require refinement to scale. A low index value 230 may indicate the innovation and/or product having weak alignment with consumer demand, having limited distribution, and facing strong competition in the market. The low index value 230 may indicate that the adoption of the product may be limited to niche groups or that the product may require repositioning or refinement.

In some embodiments, the index value 230 may be subject to scenario simulation and sensitivity analysis. In some embodiments, one or more of the data inputs 202-218 may include simulated data which may be used to determine an effect of a change in the data on the index value 230. For example, the effects of changing a number of variations offered at a location may be simulated, generating a simulated index value 230 which may indicate whether such a change is desirable. Thus, the systems described herein may perform the scenario simulation using an iterative approach whereby one or more variables (e.g., data values) are adjusted during each simulation to generate potentially different index values. The systems described herein may perform such simulation for any suitable number of iterations to determine a maximum/optimal index value. In some embodiments, the systems described herein (e.g., machine learning module 130) may leverage regression-based sensitivity scoring to evaluate the sensitivity of the index value to changes in various index component values and input data, which may be used to optimize the index value.

### Generating and Updating Weighting Values

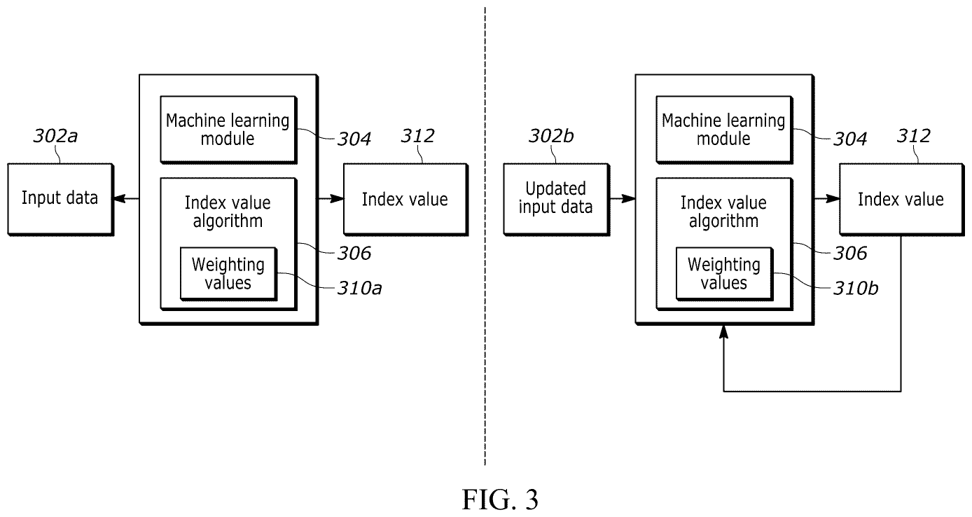

FIG. 3 depicts an example scenario for generating and iteratively updating weighting values, such as the weighting values of an index value and index component values. Input data 302a may include various data such as alignment data, reach data, acceptance rate data, impact range data, penetration data, distribution data, effectiveness data, regional data, and/or substitution data. In some embodiments, the input data 302a may include budget data such as an actual budget and/or an ideal budget. An index value algorithm 306 may receive the input data 302a. In some embodiments, a machine learning module 304 may receive the input data 302a to generate data components that may be used to calculate index component values. For example, the machine learning module 304 may be used to predict sales projection data, identify sentiment towards a trait and generate an interest score based on the sentiment, generate demographic groups, etc.

The index value algorithm 306 may include one or more weighting values 310a. Data components (e.g., motivational score for product attribute, average motivational score in category, potential reach in target segment, benchmark reach in category, interest score, sales projection, time-to-market, motivational reach for product trait, average trait influence, retail locations with product, total target retail locations, current locations with product, total target locations, variations stocked by retailer, total variations offered, average price in location, national average price, competitor product launches, market share of competitor products, and/or category growth rate) used to calculate index component values (e.g., alignment value, reach value, acceptance rate value, impact range value, penetration value, distribution value, effectiveness value, regional value, and/or substitution value) may be weighted with the one or more weighting values 310a. For example, the weighting values 310a may be used to weight a potential reach in a target segment that is used to determine an alignment value. Additionally or alternatively, the index component values may be weighted with the one or more weighting values 310a. For example, an index value algorithm 306 may include an alignment value weighted with one of the weighting values 310a and an reach value weighted with another of the weighting values 310a. The index value algorithm 306 may be used to generate an index value 312. In some embodiments, the weighting values may be adjusted based on one or more budget constraints. For example, a weighting value may be calculated using the equation:

$${W}_{adjusted} = W \times ( Actual Budget / Ideal Budget ) \qquad ( 12 )$$

In some embodiments, the weighting values 310a may include corrective weighting to adjust for anomalies. The machine learning module 304 may detect outliers (e.g., anomalies) in the input data 302a. For example, the demand for an object in a region may be unexpectedly and/or unusually high, affecting a regional value, effectiveness value, penetration value, and/or distribution value. The anomalous demand for the object may be detected by the machine learning module 304, and the weighting values 310a may be adjusted to prevent the anomalous demand from skewing the index value 312. The machine learning module 304 may use unsupervised machine learning techniques and algorithms such as autoencoders, isolation forests, clustering, one-class support vector machine, etc., to identify anomalies and/or outliers. In some embodiments, statistical methods such as z-scores and/or interquartile range calculates may be used to determine outliers.

The machine learning module 304 and/or the index value algorithm 306 may next receive updated input data 302b. The updated input data 302b may include updated data for one or more of the alignment data, reach data, acceptance rate data, impact range data, penetration data, distribution data, effectiveness data, regional data, and/or substitution data. In some embodiments, the updated input data 302b may be received in real-time. The updated input data 302b may cause the machine learning module 304 to generate updated weighting values 310b. The updated input data 302b may be used to update the weighting values for the data components that are used to calculate index component values. Additionally or alternatively, the updated input data 302b may be used to update the weighting values for the index component values when determining the index value. The index value 312 may also be fed back to the machine learning module 304 to update a machine learning model, weighting values 310b, and/or other predictions generated by the machine learning model. Further, any other values or data retrieved, accessed, tracked, and/or otherwise utilized as part of the techniques described herein may be used as part of a re-training and/or a reinforcement learning process (e.g., to update a machine learning model of the machine learning module 304), as generally illustrated in FIG. 3.

In some embodiments, the machine learning model trained and operated by the machine learning module 304 may utilize reinforcement learning to generate updated weighting values 310b. A machine learning model may receive a user-defined reward signal, which may include a positive reward for weighting values 310a that cause more accurate predictions (e.g., the index value indicating a probability of success matches an actual performance of the object), and a negative reward for weighting values that cause less accurate predictions. The machine learning model may receive input data 302a and generate a weighting value 310a based upon the input data 302a. The machine learning model may also receive a reward signal based upon the reward signal definition and the output weighting value 310a, and alter the decision-making model so as to receive a stronger reward signal for subsequently generated weighting values 310b.

In some embodiments, generating the updated weighting values 310b may utilize a Bayesian updating process. A Bayesian updating process uses new information and prior beliefs to update the probability of prior hypotheses. The updated input data 302b may be used to adjust the initial weighting values 310a based on changes to marketing strategy. For example, the updated input data 302b may include updated acceptance rate data (e.g., updated interest data and/or sales data) caused by increased marketing in a particular region, which may be used to dynamically update the initial weighting values 310a for an interest score and/or sales projection data component used to calculate an acceptance rate value.

In some embodiments, the updated weighting values 310b of the index value component values may be based on time. For example, an acceptance rate value may be given a higher weighting value when an object or product first launches, but a regional value may be given a higher weighting value as the object's market presence grows. The weighting values may be based on a stage of the object's life cycle, such as a launch stage, a growth stage, and a maturity stage. During a launch stage (i.e., phase in which a product is first introduced to the market), an alignment value and/or acceptance rate value may be given a higher weight. In a growth stage (i.e., phase during which a product's presence in the market grows), weighting values may be more balanced for a penetration value and/or regional value. In a maturity stage (i.e., phase in which product has been on market for a time and growth has slowed), higher weighting values may be given to an effectiveness value and/or regional value.

In some embodiments, the weighting values may be adjusted based on updated budget data such as an updated actual budget and/or ideal budget. The updated weighting values 310b may be determined using the updated budget data and equation (12) listed above.

### Example Method for Improved Modular Predictive Analysis

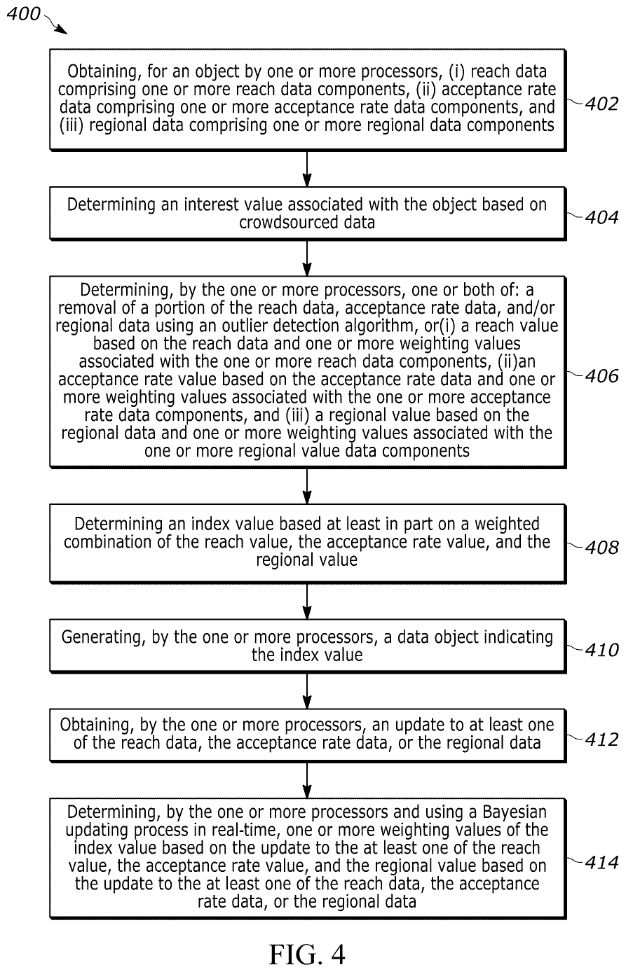

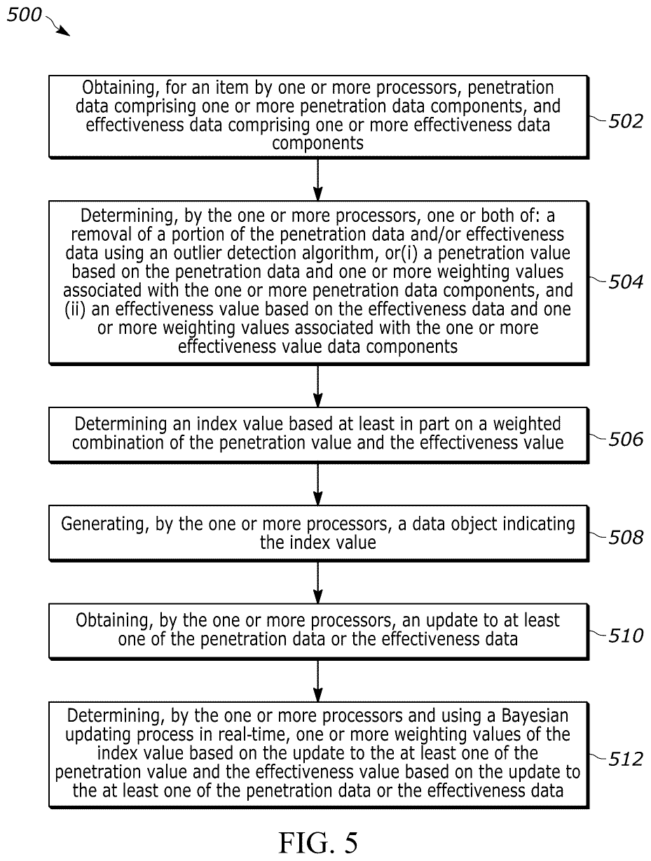

FIG. 4 depicts a block diagram of an example method 400 for improved modular predictive analysis. The actions described herein in reference to the example method 400 may be performed by any of the components of the example computing system 100 (e.g., central server 102, index value algorithm 132, etc.).

The method 400 may begin at block 402 and may include obtaining, for an object by one or more processors, (i) reach data comprising one or more reach data components, (ii) acceptance rate data comprising one or more acceptance rate data components, and (iii) regional data comprising one or more regional data components.

At block 404, the method 400 may include determining an interest value associated with the object based on crowdsourced data. In some embodiments, determining the interest value may include obtaining, by the one or more processors, at least one of post data including an object and determining, by a trained machine learning model, a sentiment towards the object. The method 400 may include determining, by the one or more processors, the interest value based on the sentiment.

At block 406, the method 400 may include determining, by the one or more processors, one or both of a removal of a portion of the reach data, acceptance rate data, and/or regional data using an outlier detection algorithm; or determining, by the one or more processors, (i) an reach value based on the reach data and one or more weighting values associated with the one or more reach data components, (ii)an acceptance rate value based on the acceptance rate data and one or more weighting values associated with the one or more acceptance rate data components, and (iii) a regional value based on the regional data and one or more weighting values associated with the one or more regional data components.

In some embodiments, the one or more weighting values associated with the one or more reach data components, the one or more weighting values associated with the one or more acceptance rate data components, and/or the one or more weighting values associated with the one or more regional data components may be based on a dynamic weighting algorithm. In some embodiments, the method 400 may further include dynamically updating, based on the real-time update to the at least one of the reach data, the acceptance rate data, or the regional data, at least one of: (i) the one or more weighting values associated with the one or more reach data components, (ii) the one or more weighting values associated with the one or more acceptance rate data components, and (iii) the one or more weighting values associated with the one or more regional data components.

In some embodiments, the method 400 may further include modifying the acceptance rate value based on an exponential decay function. In some embodiments, the method 400 may further include predicting future demand for the object. The method may include obtaining, by the one or more processor, real-time sales data and updating, by a trained machine learning model, one component of the one or more components of the acceptance rate data. The method 400 may include determining, by the one or more processors, a future demand based on the updating; and updating, by the one or more processors, the acceptance rate value based on the future demand.

In some embodiments, the weighting values associated with the one or more components of the reach data may depend on at least one of the acceptance rate value or the regional value, the weighting values associated with the one or more components of the acceptance rate data may depend on at least one of the reach value or the regional value, or the weighting values associated with the one or more components of the regional data may depend on at least one of the reach value or the acceptance rate value. In some embodiments, the weighting values associated with the one or more components of the reach data, the weighting values associated with the one or more components of the acceptance rate data, and/or the weighting values associated with the one or more components of the regional data is based on a time.

At block 408, the method 400 may include determining an index value based at least in part on a weighted combination of the reach value, the acceptance rate value, and the regional value.

At block 410, the method 400 may include generating, by the one or more processors, a data object indicating the index value.

At block 412, the method 400 may include obtaining, by the one or more processors, a real-time update to at least one of the reach data, the acceptance rate data, or the regional data.

At block 414, the method 400 may include determining, by the one or more processors and using a Bayesian updating process, one or more weights of the index value based on the update to the at least one of the reach value, the acceptance rate value, and the regional value based on the update to the at least one of the reach data, the acceptance rate data, or the regional data.

In some embodiments, the method 400 may further include determining an alignment value. The method 400 may include obtaining, by the one or more processors, alignment data comprising one or more alignment data components. The method 400 may include determining one or both of a removal of a portion of the alignment data or adjusting a weighting value associated with one of the one or more components of the alignment data, and determining an alignment value based on the alignment data. The index value may be determined based at least in part on a weighted alignment value. In some embodiments, one of the one or more alignment data components may include an interest score, which may be updated. The method 400 may include obtaining, by the one or more processors, at least one of post data including an object attribute or survey data including the object attribute and determining, by a trained machine learning model, a sentiment towards the object attribute. The interest score may be updated based on the sentiment. In some embodiments, the method 400 may include identifying demographic groups likely to be interested in the object. The method 400 may include obtaining, by the one or more processors, one or more object attributes and demographic data and determining, by a trained machine learning model, an updated component of the one or more reach components based on the one or more object attributes and demographic data.

In some embodiments, the method 400 may further include determining an impact range value. The method 400 may include obtaining, by the one or more processors, impact range data comprising one or more impact range data components. The method 400 may include determining one or both of a removal of a portion of the impact range data or adjusting a weighting value associated with one of the one or more components of the impact range data, and determining an impact range value based on the impact range data. The index value may be determined based at least in part on a weighted impact range value.

In some embodiments, the method 400 may further include determining a penetration value. The method 400 may include obtaining, by the one or more processors, penetration data comprising one or more penetration data components. The method 400 may include determining one or both of a removal of a portion of the penetration data or adjusting a weighting value associated with one of the one or more components of the penetration data, and determining an penetration value based on the penetration data. The index value may be determined based at least in part on a weighted penetration value.

In some embodiments, the method 400 may further include determining a distribution value. The method 400 may include obtaining, by the one or more processors, distribution data comprising one or more distribution data components. The method 400 may include determining one or both of a removal of a portion of the distribution data or adjusting a weighting value associated with one of the one or more components of the distribution data, and determining an distribution value based on the distribution data. The index value may be determined based at least in part on a weighted distribution value.

In some embodiments, the method 400 may further include determining an effectiveness value. The method 400 may include obtaining, by the one or more processors, effectiveness data comprising one or more effectiveness data components. The method 400 may include determining one or both of a removal of a portion of the effectiveness data or adjusting a weighting value associated with one of the one or more components of the effectiveness data, and determining an effectiveness value based on the effectiveness data. The index value may be determined based at least in part on a weighted effectiveness value.

In some embodiments, the method 400 may further include determining a substitution value. The method 400 may include obtaining, by the one or more processors, substitution data comprising one or more substitution data components. The method 400 may include determining one or both of a removal of a portion of the substitution data or adjusting a substitution value associated with one of the one or more components of the substitution data, and determining an substitution value based on the substitution data. The index value may be determined based at least in part on a weighted substitution value.

In some embodiments, the method 400 may further include simulation and sensitivity testing. The method 400 may include modifying, by the one or more processors, one of the one or more of the reach data components, acceptance rate data components, or regional data components. The method 400 may include determining, by the one or more processors, a second index value based at least in part on the modifying and generating, by the one or more processors, an action based on the second index value.

In some embodiments, the method 400 may further include dynamically suggesting or updating a price of a product. The method 400 may include obtaining, by the one or more processors, attributes of a region and generating, by a trained machine learning model, a price adjustment for the object based on the attributes of the region. The method 400 may include obtaining, by the one or more processors, a demand for the object responsive to the price adjustment for the object. The trained machine learning model may then generate an updated price adjustment for the object based on the demand.

In some embodiments, the method 400 may further include predicting a number of sales for the object (e.g., a sales projection). The method 400 may include obtaining, by the one or more processors, real-time sales data and generating, by a trained machine learning model, a prediction associated with a component of the acceptance rate data.

FIG. 5 depicts a block diagram of an example method 500 for dynamic innovation prediction. The actions described herein in reference to the example method 500 may be performed by any of the components of the example computing system 100 (e.g., central server 102, index value algorithm 132, etc.).

The method 500 may begin at block 502 and may include obtaining, for an object by one or more processors, (i) penetration data comprising one or more penetration data components, and (ii) effectiveness data comprising one or more effectiveness data components.

At block 504, the method 500 may include determining, by the one or more processors, one or both of a removal of a portion of the penetration data and effectiveness data using an outlier detection algorithm, (i) a penetration value based on the penetration data and one or more weighting values and (ii) an effectiveness value based on the effectiveness data and one or more weighting values.

In some embodiments, the one or more weighting values associated with the one or more penetration data components or the one or more weighting values associated with the one or more effectiveness data components may be based on a dynamic weighting algorithm. In some embodiments, the method 400 may further include dynamically updating, based on the real-time update to the at least one of the penetration data or the effectiveness data, at least one of: (i) the one or more weighting values associated with the one or more penetration data components and (ii) the one or more weighting values associated with the one or more effectiveness data components

In some embodiments, the weighting values associated with the one or more components of the penetration data may depend on the effectiveness value, or the weighting values associated with the one or more components of the effectiveness data may depend on the penetration value.

At block 508, the method 500 may include determining an index value based at least in part on a weighted combination of the penetration value and the effectiveness value.

At block 510, the method 500 may include generating, by the one or more processors, a data object indicating the index value.

At block 512, the method 500 may include obtaining, by the one or more processors, a real-time update to at least one of the penetration data or effectiveness data.

At block 514, the method 500 may include determining, by the one or more processors and using a Bayesian updating process, one or more weights of the index value based on the update to the at least one of the penetration value and the effectiveness value based on the update to the at least one of the penetration data and effectiveness data.

In some embodiments, the method 500 may include simulation and sensitivity testing. The method 500 may include modifying, by the one or more processors, one of the one or more of the penetration data components and effectiveness data components. The method may include determining, by the one or more processors, a second index value based at least in part on the modifying and generating an action based on the second index value.

In some embodiments, the method 500 may include suggesting optimal distribution points. The method 500 may include obtaining, by the one or more processors, sales data associated with a region and updated demographic data associated with region and generating, by a trained machine learning model, one or more distribution locations based on the sales data associated with the region and updated demographic data associated with the region. The method 400 may then include obtaining real-time updated sales data associated with the region and updated demographic data associated with region and retraining, by the one or more processors, the machine learning model based on the sales data associated with the region and the demographic data of the region. One or more new distribution locations may then be generated based on the real-time updated sales data associated with the region and updated demographic data associated with the region.

In some embodiments, the method 500 may include recommending object variations to distribute at distribution locations. The method 500 may include obtaining sales data associated with a region and object variation data and generating, by a trained machine learning model, one or more object variation recommendations based on the sales data associated with the region and the object variation data. The method 500 may further include obtaining, by the one or more processors, real-time updated sales data associated with the region and retraining, by the one or more processors, the machine learning model based on the real-time updated sales data associated with the region and the object variation data. One or more new object variations may be recommended based on the real-time updated sales data associated with the region and the object variation data.

In some embodiments, the method 500 may further include determining an alignment value. The method 500 may include obtaining, by the one or more processors, alignment data comprising one or more alignment data components. The method 500 may include determining one or both of a removal a portion of the alignment data or adjusting a weighting value associated with one of the one or more components of the alignment data. The method 500 may include determining an alignment value based on the alignment data and determining the index value further based at least in part on a weighted alignment value. In some embodiments, an alignment data component may comprise an interest value. The method 500 may include updating the interest value by obtaining, by the one or more processors, at least one of post data including an object attribute or survey data including the object attribute and determining, by a trained machine learning model, a sentiment towards the object attribute. The interest value may be updated based on the sentiment.

In some embodiments, the method 500 may further include determining an impact range value. The method 500 may include obtaining, by the one or more processors, impact range data comprising one or more impact range data components and determining one or both of a removal a portion of the impact range data or adjusting a weighting value associated with one of the one or more components a variable of the impact range data. The method 500 may include determining an impact range value based on the impact range data and determining the index value further based at least in part on a weighted impact range value.

In some embodiments, the method 500 may further include determining an reach value. The method 500 may include obtaining, by the one or more processors, reach data comprising one or more reach data components and determining one or both of a removal a portion of the reach data or adjusting a weighting value associated with one of the one or more components of the reach data. The method may include determining a reach value based on the reach data and determining the index value further based at least in part on a weighted reach value. In some embodiments, the method 500 may include identifying groups likely to be interested in product. The method 500 may include obtaining, by the one or more processors, one or more object attributes and demographic data and determining, by a trained machine learning model, an updated component of the one or more reach components based on the one or more object attributes and demographic data.

In some embodiments, the method 500 may further include determining a distribution value. The method 500 may include obtaining, by the one or more processors, distribution data comprising one or more distribution data components and determining one or both of a removal a portion of the distribution data or adjusting a weighting value associated with one of the one or more components of the distribution data. The method 500 may include determining a distribution value based on the distribution data and determining the index value further based at least in part on a weighted distribution value.

In some embodiments, the method 500 may further include determining an acceptance rate value. The method 500 may include obtaining, by the one or more processors, acceptance rate data comprising one or more acceptance rate data components and determining one or both of a removal of a portion of the acceptance rate data or adjusting a weighting value associated with one of the one or more components of the acceptance rate data. The method 500 may include determining an acceptance rate value based on the acceptance rate data and determining the index value further based at least in part on a weighted effectiveness value. In some embodiments, the acceptance rate value may further be determined by modifying the acceptance rate value based on an exponential decay function.

In some embodiments, the method 500 may include tracking similar or substitute products. The method 500 may include obtaining, by the one or more processors, substitution data comprising one or more substitution data components and determining one or both of removal of a portion of the substitution data or adjusting a weighting value associated with one of the one or more components of the substitution data. The method 500 may include determining a substitution value based on the substitution data and determining the index value further based at least in part on a weighted substitution value.

In some embodiments, the method 500 may include dynamic pricing suggestion. The method 500 may include obtaining, by the one or more processors, attributes of a region and generating, by a trained machine learning model, a price adjustment for the object based on the attributes of the region. A demand for the object responsive to the price adjustment may be obtained and used by the trained machine learning model for generating an updated price adjustment for the object based on the demand.

### Additional Considerations

The following considerations also apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

It should also be understood that, unless a term is expressly defined in this patent using the sentence “As used herein, the term” “is hereby defined to mean . . .” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112(f).

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for implementing the concepts disclosed herein, through the principles disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for improved modular predictive analysis comprising:
obtaining, for an object by one or more processors, (i) penetration data comprising one or more penetration data components, and (ii) effectiveness data comprising one or more effectiveness data components;
determining, by the one or more processors, one or both of:
a removal of a portion of the penetration data, and/or effectiveness data using an outlier detection algorithm, or
(i) a penetration value based on the penetration data and one or more weighting values associated with the one or more penetration data components and (ii) an effectiveness value based on the effectiveness data and one or more weighting values associated with the one or more penetration value components;
determining, by the one or more processors, an index value based at least in part on a weighted combination of the penetration value and the effectiveness value;
generating, by the one or more processors, a data object indicating the index value;
obtaining, by the one or more processors, an update to at least one of the penetration data or the effectiveness data; and
determining, by the one or more processors and using a Bayesian updating process in real-time, an updated index value based on the updating to the penetration value or the effectiveness value.

2. The method of claim 1, further comprising:
dynamically updating, in real-time and based on the update to the at least one of the penetration data or the effectiveness data, at least one of: (i) the one or more weighting values associated with the one or more penetration data components, and (ii) the one or more weighting values associated with the one or more effectiveness data components.

3. The method of claim 1, wherein at least one of the one or more weighting values associated with one or more penetration data components and the one or more weighting values associated with the one or more effectiveness data components is determined via a trained machine learning model, further comprising:
adjusting, by the one or more processors, a machine learning model parameter based on the update to the at least one of the penetration data and the effectiveness data.

4. The method of claim 1, further comprising:
modifying, by the one or more processors, one of the one or more of the penetration data components or effectiveness data components;
determining, by the one or more processors, a second index value based at least in part on the modifying;
generating, by the one or more processors, an action based on the second index value, the action including one or more of: (i) updating an amount for an object or (ii) updating a component of the one or more reach components based on one or more object attributes and demographic data.

5. The method of claim 1, wherein the weighting values associated with the one or more components of the penetration data depend on the effectiveness value and the weighting values associated with one or more components of the effectiveness data depend on the penetration value.

6. The method of claim 1, wherein the weighting values associated with the one or more components of the penetration data and the weighting values associated with the one or more components of the effectiveness data is dynamically adjustable based on an object lifecycle phase.

7. The method of claim 1, further comprising:
obtaining, by the one or more processors, acquisition data associated with a region and updated demographic data associated with region;
generating, by a trained machine learning model, one or more distribution locations based on the sales data associated with the region and updated demographic data associated with the region;
obtaining, by the one or more processors, real-time updated acquisition data associated with the region and updated demographic data associated with region;
retraining, by the one or more processors, the machine learning model based on the updated acquisition data associated with the region and the demographic data of the region; and
generating, by the trained machine learning model, one or more new distribution locations based on the real-time updated sales data associated with the region and updated demographic data associated with the region.

8. The method of claim 1, further comprising:
obtaining, by the one or more processors, acquisition data associated with a region and object variation data;
generating, by a trained machine learning model, one or more object variation recommendations based on the acquisition data associated with the region and the object variation data;
obtaining, by the one or more processors, updated acquisition data associated with the region;
retraining, by the one or more processors and in real-time, the machine learning model based on the updated acquisition data associated with the region and the object variation data; and
generating, by the trained machine learning model, one or more new object variations based on the updated acquisition data associated with the region and the object variation data.

9. The method of claim 1, further comprising:
obtaining, by the one or more processors, alignment data comprising one or more alignment data components;
determining one or both of removing a portion of the alignment data or adjusting a weighting value associated with one of the one or more components of the alignment data;
determining an alignment value based on the alignment data; and
determining the index value further based at least in part on a weighted alignment value.

10. The method of claim 6, wherein one of the one or more alignment data components comprises an interest value and further comprising: (updating motivational scores)
obtaining, by the one or more processors, post data, wherein the post data mentions an object; dividing, by the one or more processors, the post data into one or more tokens;
determining, by applying one or more of naïve Bayes, support vector machines, or deep learning techniques to the tokens, a sentiment towards the object;
determining, by the one or more processors, the interest value based on the sentiment.

11. The method of claim 1, further comprising:
obtaining, by the one or more processors, reach data comprising one or more reach data components;
determining one or both of removing a portion of the reach data or adjusting a weighting value associated with one of the one or more components of the reach data;
determining a reach value based on the reach data; and
determining the index value further based at least in part on a weighted reach value.

12. The method of claim 1, further comprising:
obtaining, by the one or more processors, one or more object attributes and demographic data;
determining, by a trained machine learning model, an updated component of the one or more reach components based on the one or more object attributes and demographic data.

13. The method of claim 1, further comprising:
obtaining, by the one or more processors, acceptance rate data comprising one or more acceptance rate data components;
determining one or both of removing a portion of the acceptance rate data or adjusting a weighting value associated with one of the one or more components of the acceptance rate data;
determining an acceptance rate value based on the acceptance rate data; and
determining the index value further based at least in part on a weighted effectiveness value.

14. The method of claim 13, further comprising:
determining, by the one or more processors, an initial acceptance rate value;
determining, by the one or more processors, an acceptance rate value at a particular time by multiplying the acceptance rate value by an exponential decay factor, the exponential decay factor including a rate of decline and a time value.

15. The method of claim 1, further comprising:
obtaining, by the one or more processors, impact range data comprising one or more impact range data components;
determining one or both of removing a portion of the impact range data or adjusting a weighting value associated with one of the one or more components a variable of the impact range data;
determining an impact range value based on the impact range data; and
determining the index value further based at least in part on a weighted impact range value.

16. The method of claim 1, further comprising:
obtaining, by the one or more processors, distribution data comprising one or more distribution data components;
determining one or both of removing a portion of the distribution data or adjusting a weighting value associated with one of the one or more components of the distribution data;
determining a distribution value based on the distribution data; and
determining the index value further based at least in part on a weighted distribution value.

17. The method of claim 1, further comprising:
obtaining, by the one or more processors, regional data comprising one or more regional data components;
determining one or both of removing a portion of the regional data or adjusting a weighting value associated with one of the one or more components of the regional data;
determining a regional rate value based on the regional data; and
determining the index value further based at least in part on a weighted effectiveness value.

18. The method of claim 1, further comprising:
obtaining, by the one or more processors, substitution data comprising one or more substitution data components;
determining one or both of removing a portion of the substitution data or adjusting a weighting value associated with one of the one or more components of the substitution data;
determining a substitution value based on the substitution data; and
determining the index value further based at least in part on a weighted substitution value.

19. A system for improved modular predictive analysis comprising:
one or more processors; and
one or more memories having stored thereon computer-executable instructions that, when executed by the one or more processors, cause the system to: obtain, for an object, (i) penetration data comprising one or more penetration data components, and (ii) effectiveness data comprising one or more effectiveness data components;
determine one or both of:
a removal of a portion of the penetration data, and/or effectiveness data using an outlier detection algorithm, or
(i) a penetration value based on the penetration data and one or more weighting values associated with the one or more penetration data components and (ii) an effectiveness value based on the effectiveness data and one or more weighting values associated with the one or more penetration value components;
determine an index value based at least in part on a weighted combination of the penetration value and the effectiveness value;
generate a data object indicating the index value;
obtain an update to at least one of the penetration data or the effectiveness data; and
determine, by using a Bayesian updating process in real-time, an updated index value based on the updating to the penetration value or the effectiveness value.

20. A non-transitory computer-readable medium, having stored thereon instruction that, when executed, cause a computer to:
determine one or both of:
a removal of a portion of the penetration data, and/or effectiveness data using an outlier detection algorithm, or
(i) a penetration value based on the penetration data and one or more weighting values associated with the one or more penetration data components and (ii) an effectiveness value based on the effectiveness data and one or more weighting values associated with the one or more penetration value components;
determine an index value based at least in part on a weighted combination of the penetration value and the effectiveness value;
generate a data object indicating the index value;
obtain an update to at least one of the penetration data or the effectiveness data; and
determine, by using a Bayesian updating process in real-time, an updated index value based on the updating to the penetration value or the effectiveness value.
